(19) United States
(12) Patent Application Publication
(10) Pub. No.: US 2005/0163307 A1
(43) Pub. Date: Jul. 28, 2005

(54) Telephone keypad arrangement

(76) Inventor: Wang-On Kwok, Yuen Long (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 10/762,272

(22) Filed: Jan. 23, 2004

(51) Int. Cl. H04M 1/00; H04M 3/00

(52) U.S. Cl. 379/368

(57) ABSTRACT

A telephone keypad arrangement having 15 keys arranged in 3×5 array including number keys 0˜9, function keys “*” and “#” and three selector keys, and 26 English letters properly arranged in pairs and respectively bilaterally marked on the number keys and the function keys and the first selector key for entry of English letters respectively, the second selector key being for selection between space bar and symbols, the third selector key being for switching between English Letter/Number and between Capital/Lower-Case Letter selectively.

### BACKGROUND OF THE INVENTION

1. Field of the Invention

The present invention relates to telephones and, more specifically, to a telephone keypad arrangement.

2. Description of the Related Art

The keypad 2 of a telephone, as shown in FIG. 4, has the 26 English letters marked on the number keys 2˜9 21. The number keys 2˜6 are respectively marked with three English letters. The number keys 7˜9 are respectively marked with four English letters. The key “*” 22, the key “#” 23, and the number key “0” 24 are not marked with any English letters. This keypad arrangement complicates the operation of data entry. When entered message mode, the user needs to repeatedly press one single key for entry of one English letter. For example, for entry of English letter “K”, the user need to click the number key “5” twice; for entry of English letter “Z”, the user need to continuously click the number key “9” four times. This complicated operation procedure produces a barrier to many people, more particularly, to young children and old persons.

### SUMMARY OF THE INVENTION

The present invention has been accomplished under the circumstances in view. It is one object of the present invention to provide a telephone keypad, which is practical for quick entry of English letters, numbers and symbols to write a message. It is another object of the present invention to provide a telephone keypad, which enables the user to selectively switch the functions of the keys between English Letter/Number and Capital/Lower-Case Letter through one single selector key.

### BRIEF DESCRIPTION OF THE DRAWINGS

FIG. 1 is a top plain view of a telephone keypad according to the present invention.

FIG. 2 is a top plain view of a key for the telephone keypad according to the present invention.

FIG. 3 is side plain view of a key for the telephone keypad according to the present invention.

FIG. 4 is a top plain view of a telephone keypad according to the prior art.

### DETAILED DESCRIPTION OF THE PREFERRED EMBODIMENT

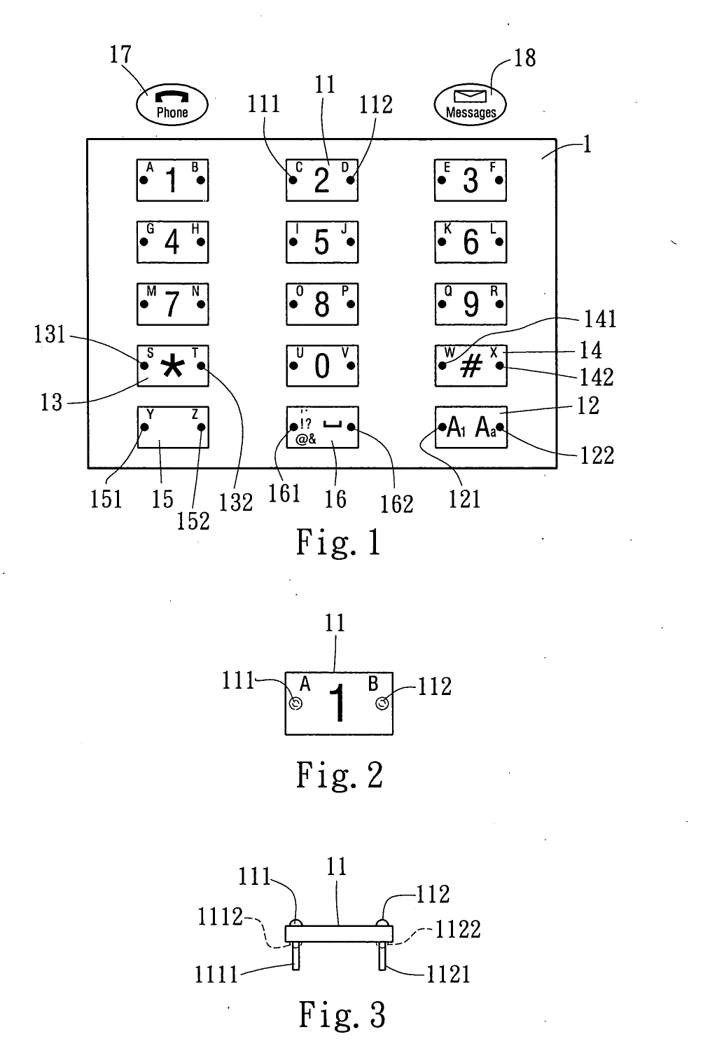

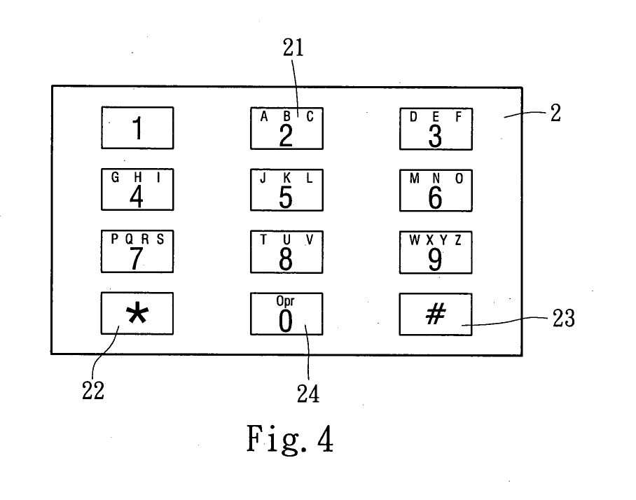

Referring to FIGS. 1-3, a telephone keypad 1 is shown comprising number keys 0˜9 11, function keys “*” 13 and “#” 14, and selector keys 15, 16, and 12. The selector keys 15, 16, and 12 are transversely arranged in a line below the number keys 11 and the function keys 13 and 14. The 26 English letters are properly arranged in pairs and respectively bilaterally marked on the number keys 11, the function keys 13 and 14, and the left-side selector key 15 near the top. The right-side selector key 12 is adapted to selectively switch the functions between English Letter/Number and the functions between Capital/Lower-Case Letter, i.e., the right-side selector key 12 has a first mark 121 at the left side for pressing by the user to switch the functions between English Letter/Number, and a second mark 122 at the right side for pressing by the user to switch the functions between Capital/Lower-Case Letter. The number keys 11, function keys 13 and 14 and left-side selector key 15 each have a first mark 111, 131, 141, 151 at the left side for entry of the respective Capital and a second mark 112, 132, 142, 152 at the right side for entry of the respective Lower-Case Letter. The middle selector key 16 is a space button, having a first mark 161 at the left side and a second mark 162 at the right side. When writing a message, the user can press the first mark 161 to select punctuation marks such as “.”, “,”, “!”, “?”, “@”, “&”, and other signs, or press the second mark 162 for entry of space. The keys 11˜16 each have a first bottom trigger rod 1111 or raised bottom trigger portion 1121 and a second bottom trigger rod 1112 or raised bottom trigger portion 1122 bilaterally disposed at the bottom side corresponding to the respective first mark and second mark for triggering the corresponding contact at the circuit board (not shown) inside the telephone.

The operation of the present invention is outlined hereinafter.

Telephone Mode—Voice:

1. When selecting voice mode, press “PHONE” button 17, the number keys 0˜9 and the function keys “*” 13 and “#” 14 are functioning corresponding to voice mode. At this time, the number keys 0˜9 and the function keys “*” 13 and “#” 14 are not functioning for entry of English letters and signs.
2. When pressing the first mark 111, 131, or 141 or the second mark 112, 132, or 142 of any of the number keys 11 and function keys 13 and 14, it achieves entry of the corresponding number or the sigh of “*” or “#”.
   Telephone Mode—Message:
1. When selecting message mode, press “MESSAGE” button 18, the number keys 0˜9 and the function keys “*” 13 and “#” 14 and the selector keys 12, 15, and 16 are functioning for entry of English letters and signs.
2. At this time, the user can press the first mark 111, 131, 141 or 151 or the second mark 122, 132, 142, or 152 of any of the number keys 11, function keys 13 and 14, and selector keys 12, 15, and 16 to achieve entry of the corresponding English Letter.
3. Switch between Capital/Lower-Case Letter or English Letter/Number: press the second mark 122 of the right-side selector key 12 for Capital/Lower-Case Letter selection, or press the first mark 121 for English Letter/Number selection.
4. Symbol and space entry: Press the first mark 161 to select punctuation marks and signs, or press the second mark 162 for entry of space.

May conventional mechanical and electronic circuit designs can be achieved to match the aforesaid keypad arrangement. However, because these mechanical and electronic circuit designs are not within the scope of the claims of the present invention, no further detailed description in this regard is necessary.

Although particular embodiments of the invention have been described in detail for purposes of illustration, various modifications and enhancements may be made without departing from the spirit and scope of the invention. Accordingly, the invention is not to be limited except as by the appended claims.

1. A telephone keypad arrangement comprising 15 keys arranged into an 3×5 array, the 15 keys including a set of number keys for entry of numbers 0˜9, two function keys “*” and “#”, and three selector keys, said selector keys including a first selector key, a second selector key and a third selector key, 26 English letters properly arranged in pairs and respectively bilaterally marked on said number keys and said function keys and said first selector key for entry of English letters respectively, said second selector key having a first mark at the left side for pressing by the user to select punctuation marks and signs and a second mark at the right side for pressing by the user for entry of space, said third selector key having a first mark at the left side for pressing by the user to switch the functions between English Letter/Number and a second mark at the right side for pressing by the user to switch the functions between Capital/Lower-Case Letter.

2. The telephone keypad arrangement as claimed in claim 1 further comprising a phone button for entry of a voice mode where said number keys 0-9 and said function keys “*” and “#” are not functioning corresponding to the voice mode and prohibited from entry of English letters and signs.

3. The telephone keypad arrangement as claimed in claim 1 further comprising a message button for entry of message mode where said number keys 0˜9 and said function keys “*” and “#” and said selector keys are functioning corresponding to the message button for-entry of English letters and signs and prohibited for entry of voice.
